(19) United States
(12) Patent Application Publication
(10) Pub. No.: US 2006/0132417 A1
(43) Pub. Date: Jun. 22, 2006

(54) Semiconductor integrated circuit for liquid crystal display driver

(75) Inventors: Takeshi Shigenobu, Kodaira (JP); Mitsuru Hiraki, Kodaira (JP); Masashi Horiguchi, Koganei (JP); Kazuo Okado, Kokubunji (JP); Takesada Akiba, Hachioji (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/311,161

(22) Filed: Dec. 20, 2005

(30) Foreign Application Priority Data
Dec. 21, 2004 (JP) 2004-368708

(51) Int. Cl. G09G 3/36

(52) U.S. Cl. 345/98

(57) ABSTRACT

In a liquid crystal drive controller formed as a semiconductor integrated circuit having therein a power source circuit including a boosting circuit and driving a source line and a gate line of a TFT liquid crystal panel, the number of external capacitive elements and the number of external terminals for connecting the external capacitive elements are reduced, thereby reducing the size and cost of the chip and an electronic device on which the chip is mounted. As a boosting circuit for generating a voltage for driving a source line of the TFT liquid crystal panel in the liquid crystal controller having therein the power source including the boosting circuit, a boosting circuit having an external capacitive element is used. On the other hand, as a boosting circuit for generating a voltage for driving a gate line, a charge pump having a built-in (on-chip) capacitive element is used.

### CROSS-REFERENCE TO RELATED APPLICATION

The present application claims priority from Japanese patent application No. 2004-368708 filed on Dec. 21, 2004, the content of which is hereby incorporated by reference into this application.

### BACKGROUND OF THE INVENTION

The present invention relates to a semiconductor integrated circuit for a liquid crystal display driver having therein a booster power source circuit for generating a voltage obtained by boosting a power source voltage and, to a technique effective when used for an LSI (Large Scale Integration circuit) for controlling liquid crystal display having therein a liquid crystal driving power source circuit for driving, for example, a TFT (Thin Film Transistor) liquid crystal display.

In recent years, as a display of a portable electronic device such as a cellular phone or PDA (Personal Digital Assistants), a dot-matrix liquid crystal panel in which a plurality of display pixels are arranged two-dimensionally in a matrix is generally used. In the device, a display controller formed as a semiconductor integrated circuit for controlling display of the liquid crystal panel, a driver circuit for driving the liquid crystal panel, or a display controller having therein such a driver circuit is mounted. The display controller formed as the semiconductor integrated circuit can operate on a voltage of 5V or less. On the other hand, a drive voltage such as 5 to 40V is necessary for display driving of the liquid crystal panel. In many cases, the display controller has therein a liquid crystal driving power source circuit that generates a voltage for driving the liquid crystal panel by boosting the power source voltage. More concretely, the liquid crystal panel is driven by a source line (segment line) drive voltage having an amplitude of about 6V and a gate line (common line) drive voltage having an amplitude (about 40V) which is a few times as large as the amplitude of about 6V.

Conventionally, a booster circuit such as a charge pump in which a switching element and a capacitive element are combined is used for the liquid crystal driving power source circuit. As the capacitive element, an external element is often used. An invention related to such a liquid crystal driving power source circuit is disclosed in, for example, Japanese Unexamined Patent Publication (JP-A) No. 2002-313925.

### SUMMARY OF THE INVENTION

A power source circuit of JP-A No. 2002-313925 uses booster circuits each having an external capacitive element as a booster circuit (10) for generating a segment line drive voltage and a booster circuit (20) for generating a common line drive voltage. Each of the booster circuits has a plurality of capacitive elements for boosting which are connected in series after pre-charging. Consequently, the number of external capacitive elements and the number of external terminals for connecting the external capacitive elements are large. There is a problem such that it is difficult to reduce the size and cost of each of a TFT liquid crystal display (hereinbelow, called a TFT liquid crystal panel), a semiconductor integrated circuit for a liquid crystal display which drives the TFT liquid crystal panel, and an electronic device on which the semiconductor integrated circuit is mounted.

In JP-A No. 2002-313925, a boosting circuit for precharging a plurality of capacitive elements with charges and, after that, connecting the capacitive elements in series, thereby obtaining a boosted voltage is called a charge pump. In the present invention, a circuit of such a boosting method will be called a switched-capacitor-type boosting circuit. A boosting circuit for boosting a voltage step by step by inserting a rectifying element or switch element between a plurality of capacitive elements provided in parallel so that backflow of charges is prevented, and alternately sending a two-phase clock to a terminal on the side opposite to the capacitive element, thereby sequentially transferring the charges to the capacitive elements in post stage will be called a charge pump which is distinguished from the switched-capacitor-type boosting circuit.

An object of the present invention is to reduce the size and cost of a chip and an electronic device on which the chip is mounted by decreasing the number of external capacitive elements and the number of external terminals for connecting the external capacitive elements in a liquid crystal drive controller having therein a power source circuit including a boosting circuit and formed as a semiconductor integrated circuit for driving a source line and a gate line of a TFT liquid crystal panel.

Another object of the invention is to reduce the cost of a chip by enabling a low-withstand-voltage process to be employed in a liquid crystal drive controller having therein a power source circuit including a boosting circuit and, particularly, formed as a semiconductor integrated circuit for driving a source line and a gate line of a TFT liquid crystal panel.

Further another object of the invention is to reduce power consumption of a boosting circuit and to stabilize an output boosted voltage in a liquid crystal drive controller having a power source circuit including a boosting circuit and formed as a semiconductor integrated circuit.

The above and other objects of the present invention and novel features will become clear from the description of the specification and the appended drawings.

An outline of a representative one of inventions disclosed in the application will be described as follows.

In a liquid crystal drive controller having therein a power source circuit including a boosting circuit and formed as a semiconductor integrated circuit for driving a source line and a gate line of a TFT liquid crystal panel, a boosting circuit having an external capacitive element is used as a boosting circuit for generating a voltage for driving a source line. On the other hand, a charge pump having a built-in (on-chip) capacitive element is used as a boosting circuit for generating a voltage for driving a gate line.

The inventors of the present invention have examined that, in a liquid crystal drive controller for driving a source line and a gate line of a TFT liquid crystal panel, current capability of a driver for driving a gate line may be much lower than that of a driver for driving a source line. Consequently, even when a built-in (on-chip) capacitive element is used for a boosting circuit as a component of a power source circuit that generates a power source voltage to be supplied to the driver for driving a gate line, necessary current can be supplied. In the above-described means, the charge pump having the built-in (on-chip) capacitive element is used as the boosting circuit that generates a voltage for driving a gate line. While assuring necessary current capability, the number of external elements and the number of external terminals can be reduced as compared with those in the boosting circuit using an external capacitive element. Thus, reduction in the size and cost of the chip and reduction in the size and cost of an electronic device on which the chip is mounted can be achieved.

Desirably, as the built-in (on-chip) capacitive element, capacitive elements connected in series are used and a voltage divided by a resistor is applied to the connection point of the capacitive elements. With the configuration, a voltage applied to each of the capacitive elements for boosting can be made smaller, so that the withstand voltage of the capacitive element can be reduced. In a boosting circuit having a voltage adjusting circuit including a comparator and an error amplifier and capable of adjusting the level of a boosted voltage, a variable resistor for dividing the boosted voltage is provided on not the output terminal side but the power source voltage (constant potential) terminal side. When the variable resistor is provided on the output terminal side, adjustment precision is higher (adjustment is easier). However, by providing the variable resistor on the power source voltage terminal side, the withstand voltage of a switch element as a component of the variable resistor can be decreased.

Further, desirably, the boosting circuit that generates a voltage for driving the gate line is constructed by a charge pump. The number of stages of the charge pump is made switchable to switch the number of stages of the charge pump in accordance with, for example, the specifications of the display panel, the display mode, or the operation mode. With the configuration, power consumption of the charge pump is reduced and power efficiency can be improved.

Effects obtained by the representative one of the inventions disclosed in the application will be briefly described as follows.

According to the invention, in the liquid crystal drive controller having therein a power source circuit including a boosting circuit and formed as a semiconductor integrated circuit for driving a source line and a gate line of a TFT liquid crystal panel, by decreasing the number of external capacitive elements and the number of external terminals for connecting the external capacitive elements, the size and cost of the chip and the electronic device on which the chip is mounted can be reduced.

Further, according to the invention, the low-withstand-voltage process can be employed, and the cost of the chip can be reduced. Further, power consumption of the boosting circuit can be reduced and the output boosted voltage can be stabilized.

### BRIEF DESCRIPTION OF THE DRAWINGS

FIG. 1 is a block diagram showing the configuration of a liquid crystal display constructed by a liquid crystal control driver having a booster power source circuit and a TFT liquid crystal panel driven by the driver.

FIG. 2 is a block diagram showing an example of a booster power source circuit for a gate driver in the liquid crystal control driver to which the invention is applied.

FIG. 3A is a circuit diagram showing an example of a charge pump for generating a positive boost voltage having a gate drive waveform, and FIG. 3B is a circuit diagram showing an example of a charge pump for generating a negative boost voltage.

FIG. 4 is a waveform chart showing a gate drive waveform and a source drive waveform.

FIG. 5 is a waveform chart showing the waveform of a clock that operates the charge pump.

FIG. 6 is an equivalent circuit diagram showing a pixel model of the TFT liquid crystal panel.

FIG. 7 is a circuit diagram showing an example of a booster power source for driving a source.

FIG. 8A is an operation diagram showing a switch state and a current path at the time of charging of a booster circuit of a power source circuit in FIG. 7, and FIG. 8B is an operation diagram showing a switch state and a current path at the time of voltage boosting of the booster circuit of the power source circuit in FIG. 7.

FIG. 9 is a circuit diagram showing an example of a capacitive element as a component of a charge pump of the booster power source circuit for the gate driver of the embodiment.

FIG. 10 is a circuit diagram showing a second example of the booster power source circuit for the gate driver according to the invention.

FIG. 11A is a circuit configuration diagram showing a third example of the booster power source circuit for the gate driver according to the invention, and FIG. 11B is a circuit diagram showing an example of the configuration of the main part.

FIG. 12 is a circuit diagram showing the configuration of a charge pump used for a fourth example of the booster power source circuit for the gate driver according to the invention.

FIG. 13 is a circuit diagram showing the configuration of a charge pump used for a fifth example of the booster power source circuit for the gate driver according to the invention.

### DETAILED DESCRIPTION OF THE PREFERRED EMBODIMENTS OF THE INVENTION

Preferred embodiments of the invention will be described hereinbelow with reference to the drawings.

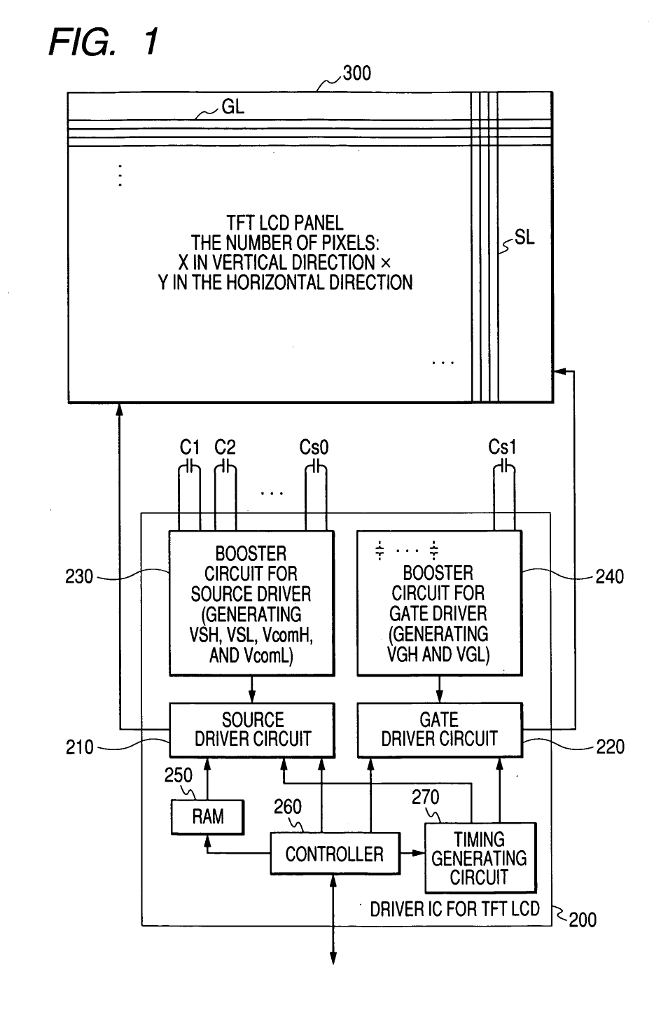

First, a semiconductor integrated circuit 200 for controlling liquid crystal display having therein a booster power source circuit to which the present invention is effectively applied will be described with reference to FIG. 1. FIG. 1 is a block diagram showing the configuration of a liquid crystal display constructed by the liquid crystal control driver 200 having there in the booster power source circuit and a TFT liquid crystal panel 300 driven by the driver.

In FIG. 1, 200 denotes the liquid crystal control driver LSI for driving a liquid crystal panel by an active matrix method to display an image, and 300 denotes the TFT liquid crystal panel driven by the liquid crystal control driver LSI 200. The liquid crystal control driver LSI 200 includes: a source driver 210 for driving source lines (source electrodes) SL of the TFT liquid crystal panel 300 in accordance with an image signal; a gate driver 220 for sequentially scanning gate lines (gate electrodes) GL of the TFT liquid crystal panel 300; a booster power source circuit 230 for the source driver, for generating a drive voltage necessary for the source driver 210; a booster power source circuit 240 for the gate driver, for generating a drive voltage necessary for the gate driver 220, a display RAM 250 storing image data to be displayed on the liquid crystal panel 300 in a bit map method; a controller 260 for controlling the inside of the chip on the basis of an instruction from an external microprocessor (hereinbelow, also called an MPU or CPU); and a timing generating circuit 270 for generating a clock which gives operation timings of the source driver 210 and the gate driver 220. Those circuits are formed on a single semiconductor chip such as single-crystal silicon. The LSI 200 has an external terminal to which a power source voltage Vcc such as a first potential is supplied and an external terminal to which a ground potential such as a second potential is supplied.

To the booster power source circuit 230 for the source driver, capacitive elements C1, C2, . . . for boosting and a smoothing capacitor Cs0 for stabilizing an output voltage are connected as external elements. To the booster power source circuit 240 for the gate driver, a smoothing capacitor Cs1 is connected as an external element, and a capacitive element for boosting is provided as an internal (on-chip) element. Although not shown, the liquid crystal control driver 200 includes an address counter for generating an address to the RAM 250 for display, an arithmetic and logic unit for executing logic operation for watermark display or superimpose display on the basis of data read from the RAM 250 for display and new display data supplied from an external MPU or the like, and an interface circuit for transmitting/receiving a signal to/from an MPU (microprocessor) as an external system controller.

As a control method of the controller 260, an arbitrary control method can be employed such as a method of receiving a command code from an external MPU, decoding it, and generating a control signal or a method of preparing a plurality of command codes in the controller, and a register (called an index register) for instructing a command to be executed, and designating a command to be executed by writing the index register by the MPU, thereby generating a control signal.

Under the control of the controller 270 constructed as described above, at the time of displaying an image on the TFT liquid crystal panel 300 on the basis of the instruction and data from the external MPU, the liquid crystal control driver LSI 200 performs a drawing process of sequentially writing display data onto the display RAM 250 and a reading process of sequentially reading display data from the display RAM 250 to output a signal to be applied to the source line SL in the TFT liquid crystal panel 300 and a signal to be applied to the gate line GL, thereby performing liquid crystal display.

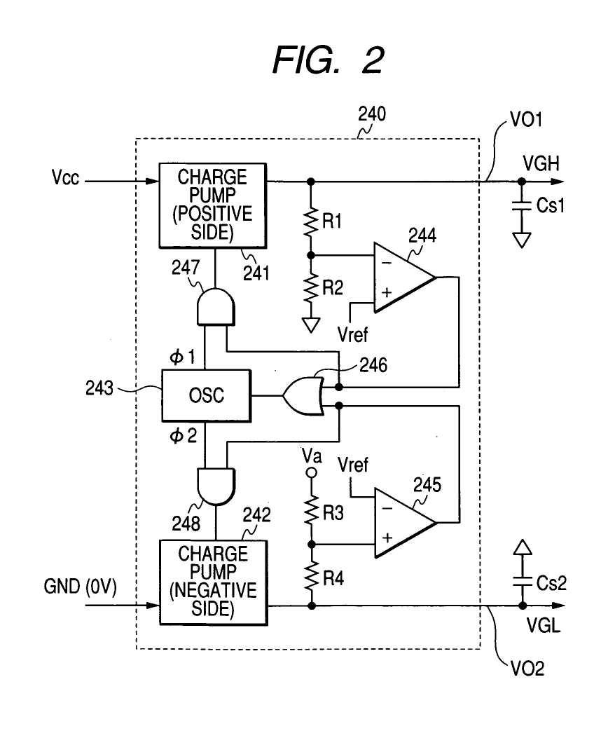

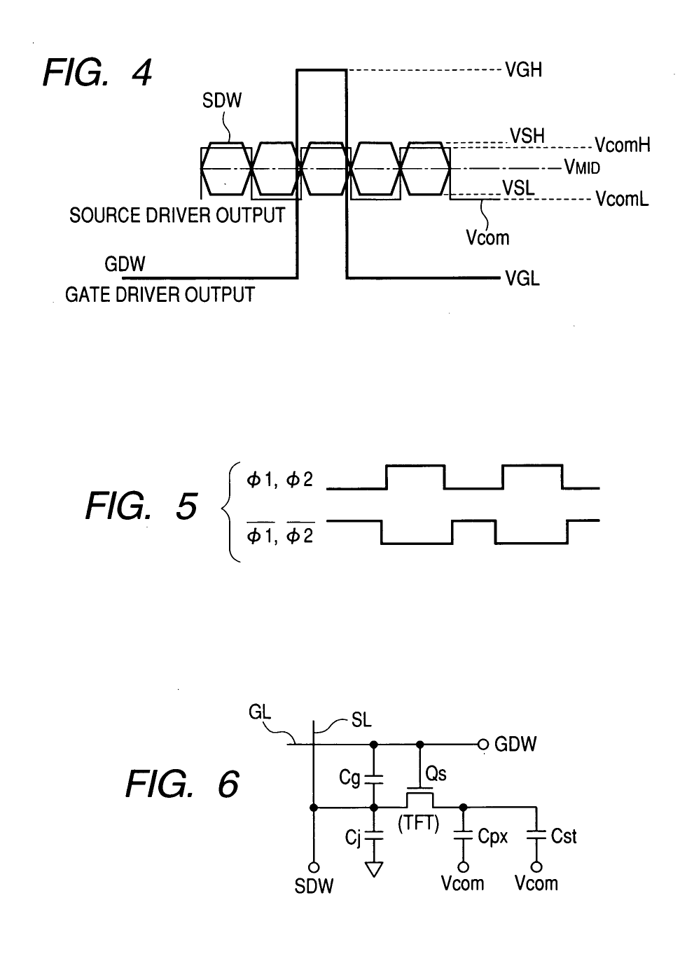

FIG. 2 shows an example of the booster power source circuit 240 for the gate driver in the liquid crystal control driver to which the invention is applied. The booster power source circuit 240 for the gate driver includes, as shown in FIG. 4, a charge pump 241 for generating a positive boosting voltage VGH of a gate drive waveform GDW, a charge pump 242 for generating a negative boosting voltage VGL, a common oscillation circuit 243 for generating two-phase clocks that operate the charge pumps, a comparator 244 for detecting the level of the boosting voltage VGH generated by the positive charge pump 241, and a comparator 245 for detecting the level of the boosting voltage VGL generated by the negative charge pump 242. To voltage output terminals V01 and V02 of the booster power source circuit 240, the smoothing capacitor Cs1 for stabilizing the positive boosting voltage VGH and the smoothing capacitor Cs2 for stabilizing the negative boosting voltage VGL are connected as external elements.

Clocks φ1 and /φ1 from the oscillation circuit 243 are supplied to the charge pump 241 via an AND gate 247, and a voltage obtained by dividing the positive boosting voltage VGH by resistors R1 and R2 and a reference voltage Vref are input to the comparator 244. When the boosting voltage VGH becomes a predetermined level or higher, the output changes to the low level, the AND gate 247 is closed to interrupt supply of the clocks, and operation of the charge pump 241 is stopped. Clocks φ2 and /φ2 from the oscillation circuit 243 are supplied to the charge pump 242 via an AND gate 248, and a voltage obtained by dividing the potential difference between the negative boosting voltage VGL and a constant voltage Va by resistors R3 and R4 and the reference voltage Vref are input to the comparator 245. When the boosting voltage VGL becomes a predetermined level or lower, the output changes to the low level, the AND gate 248 is closed to interrupt supply of the clocks, and operation of the charge pump 242 is stopped. In such a manner, a boosting voltage at a desired level can be generated.

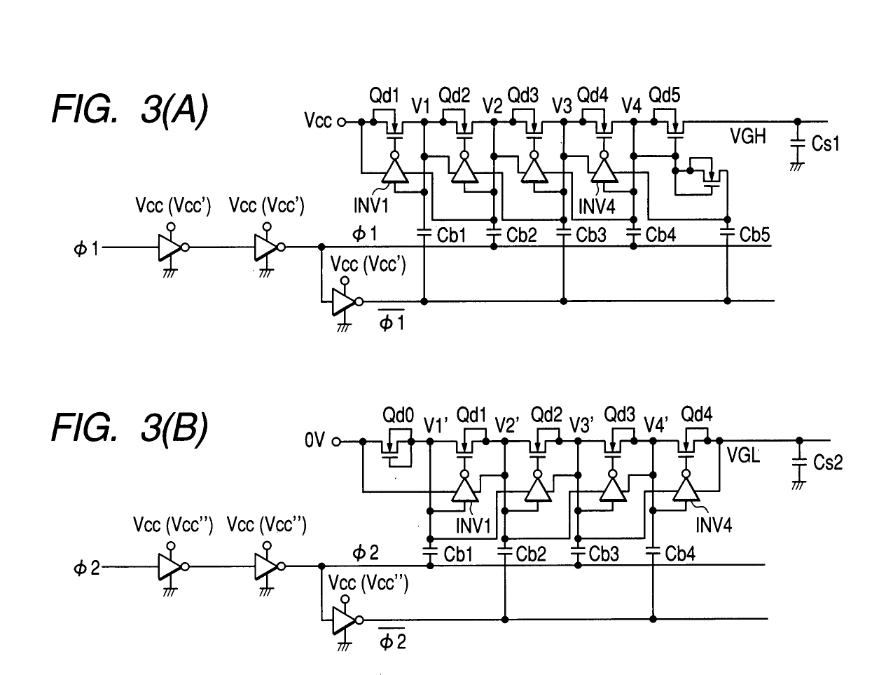

Outputs of the comparators 244 and 245 are input to an OR gate 246. When both of the outputs become the low level, the operation of the oscillation circuit 243 is stopped. Consequently, when outputs of the charge pumps on the positive and negative sides become the required levels, generation of clocks is stopped, so that useless consumption current can be prevented from flowing. To enable the same constant voltage (for example, 2V) to be used as the reference voltage Vref of the comparator 244 and the reference voltage Vref of the comparator 245, the ratio between the resistors R1 and R2, the ratio between the resistors R3 and R4, and the level (for example, 3V) of the constant voltage Va are set. As the charge pump 241, a circuit as shown in FIG. 3A is used. As the charge pump 242, a circuit as shown in FIG. 3B is used.

In the charge pumps, MOS transistors (insulated-gate field-effect transistors) Qd1, Qd2, . . . connected in series are alternately turned on/off by the clocks φ1 and /φ1 (φ2 and /φ2) of almost opposite phases generated so that their high level periods do not overlap each other as shown in FIG. 5, and charges accumulated in a boosting capacitive element Cb1 at the first stage is sequentially transferred to Cb2, Cb3, . . . , and Cs1 (Cs2), thereby generating the boosted voltage VGH (VGL). Inverters INV1, INV2, . . . for generating gate control voltages of the MOS transistors Qd1, Qd2, . . . are connected so that the boosted voltages at the next stage and the immediately preceding stage operate as power source voltages. With the configuration, the charge pumps can be constructed by low-withstand-voltage elements, resistance when the MOS transistors Qd1, Qd2, . . . are turned on can be made relatively low, and high-efficiency charge pumps can be realized.

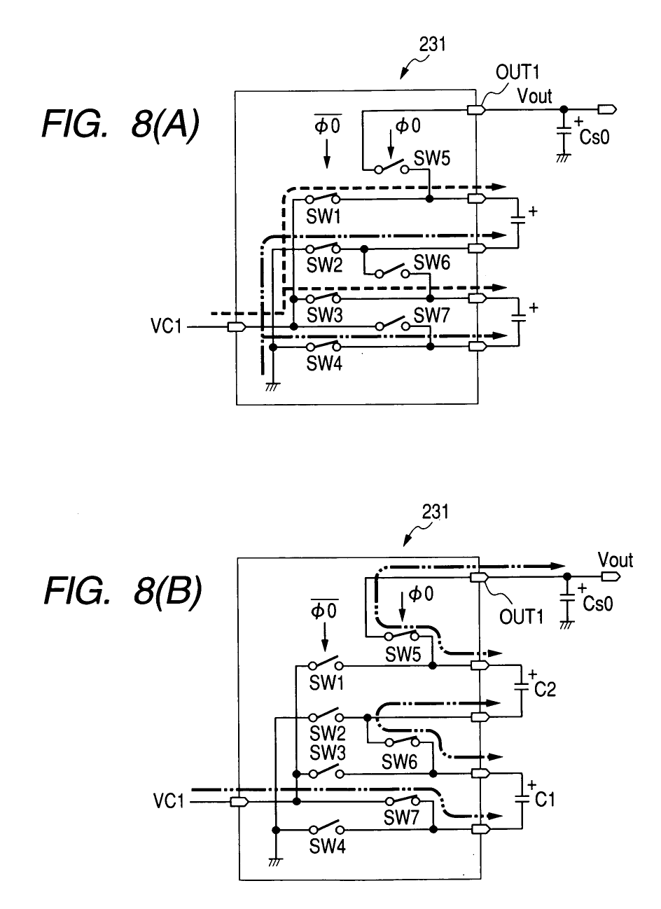

The charge pumps shown in FIGS. 3A and 3B are an example. Charge pumps which can be used in the invention are not limited to have such configurations. For example, a charge pump connecting the inverters INV1, INV2, . . . so as to use, as the power source voltage, the boosting voltage of the stage after the next stage in place of the boosting voltage of the next stage may be employed. Alternately, a charge pump using a boosting capacitor for boosting the gate voltage of a MOS transistor as shown in FIG. 8 of Japanese Unexamined Patent Publication No. 2002-025287 may be used. In this case, it is desirable to use an on-chip element as the boosting capacitor like the boosting capacitive elements Cb1, Cb2, Cb3, . . . Further, a charge pump in which the gates and drains of the MOS transistors Qd1, Qd2, . . . are connected so as to operate as diodes without providing the inverters for driving the gates of the MOS transistors Qd1, Qd2, . . . and the boosting capacitor, or a conventional charge pump using diodes in place of MOS transistors may be also used.

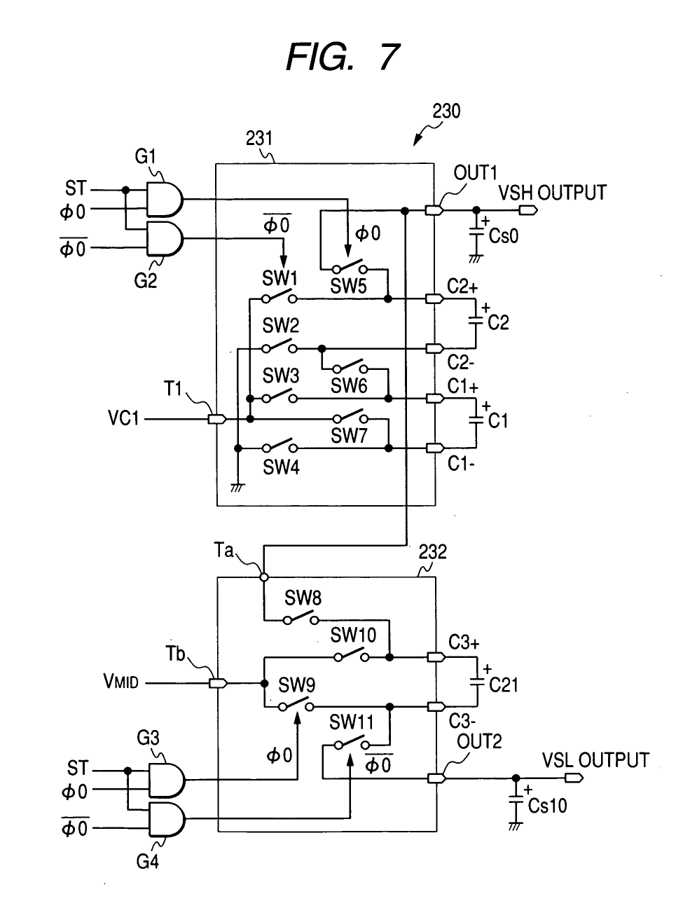

FIG. 7 shows a concrete circuit configuration example of the booster power source circuit 230 for the source driver. As obvious from FIG. 4 showing the waveform of the voltage applied to the source line SL and the gate line GL of the TFT liquid crystal panel, to generate a source driving voltage waveform SDW to be applied to the source line SL, voltages VSH and VSL symmetrical with respect to the liquid crystal center potential VMID as a center are necessary.

In the embodiment, as shown in FIG. 7, the booster power source circuit 230 for the source driver is constructed by a booster circuit 231 for generating the positive voltage VSH and a voltage inverting circuit 232 for generating the negative voltage VSL by inverting the output voltage of the boosting circuit 231 with VMID as a center. To drive the TFT liquid crystal panel, voltages VcomH and VcomL for generating AC waveform to be applied to the electrode on the substrate side facing a pixel electrode are necessary. Since the voltages can be generated by shifting the levels of the voltages VSH and VSL, it is unnecessary to provide boosting circuits, so that they are not shown and described.

The boosting circuit 231 and the voltage inverting circuit 232 of the embodiment have AND gates G1 and G2 and AND gates G3 and G4 on which clock supply control is performed by a start signal ST of the power source circuit. When the start signal ST is at the low level, supply of the clocks φ0 and /φ0 is interrupted and the boosting operation is not performed. When the start signal ST is at the high level, the clocks φ0 and /φ0 are supplied and the boosting operation starts.

The boosting circuit 231 for generating the positive source voltage VSH is constructed by switches SW1 to SW4 which are turned on/off according to the clock signal φ0, switches SW5 to SW7 which are turned on/off according to the clock signal /φ0 generated so that its high level period does not overlap with that of the clock signal φ0, boosting capacitors C1 and C2 formed in series by the switches SW5 to SW7, and the smoothing capacitor Cs0 whose output is connected to an output terminal OUT1.

A terminal C1− on a low potential side of the boosting capacitor C1 can be connected to the ground point or a first reference potential terminal T1 via the switch SW4 or SW7, and a terminal C1+ on a high potential side of the boosting capacitor C1 can be connected to the first reference potential terminal T1 via the switch SW3. A terminal C2− on a low potential side of the boosting capacitor C2 can be connected to the ground point via the switch SW2, and a terminal C2+ on a high potential side of the boosting capacitor C1 can be connected to the first reference potential terminal T1 via the switch SW1.

Further, the output terminal OUT1 and the terminal C2+ on the high potential side of the boosting capacitor C2 can be connected to each other via the switch SW5, and the terminal C2− on the low potential side of the boosting capacitor C2 and the terminal C1+ on the high potential side of the boosting capacitor C1 can be connected to each other. A constant voltage Vc1 is applied to the first reference potential terminal T1.

In the boosting circuit 231 constructed as described above, while the clock signal φ0 is set to the high level and the switches SW1 to SW4 are turned off (at this time, the switches SW5 to SW7 are turned off) as shown in FIG. 8A, the boosting capacitors C1 and C2 are charged to the level of the reference voltage Vc1. Next, the switches SW1 to SW4 are turned off and the switches SW5 to SW7 are turned on, so that the boosting capacitors C1 and C2 are formed in series as shown in FIG. 8B, and the terminal C1− on the reference terminal side of the boosting capacitor C1, that is, on the low potential side is connected to the first reference potential terminal T1 via the switch SW7. By the operation, the voltage of the output terminal OUT1 is boosted to the level which is triple as high as that of Vc1. By repeating the charging operation and boosting operation, charges charged in the boosting capacitor C2 are transferred to the smoothing capacitor Cs0 connected to the output terminal OUT1, and the boosted voltage VSH of 3Vc1 is output.

The voltage inverting circuit 232 is constructed by a voltage terminal Ta to which the positive boosted voltage VSH generated by the boosting circuit 231 is applied, a second reference voltage terminal Tb to which the liquid crystal center potential VMID is applied, a voltage inverting capacitor C21, the switch SW8 and a switch SW10 connected between one of terminals of the capacitor C21 and the voltage terminal Ta and the voltage terminal Tb and the output terminal OUT2, and a smoothing capacitor Cs10 for negative voltage connected between the output terminal OUT2 and the ground point.

The voltage inverting circuit 232 is operated in the following manner. The switches SW8 and SW9 are turned on and the switches SW10 and SW11 are turned off by the clocks φ0 and /φ0 which are set so that their high level periods do not overlap each other to charge the voltage inverting capacitor C21 with a voltage corresponding to the potential difference between the positive boosting voltage VSH and the liquid crystal center potential VMID. After that, by turning off the switches SW8 and SW9 and turning on the switches SW10 and SW11, the smoothing capacitor Cs10 connected to the output terminal OUT2 is charged with the negative voltage VSL having the polarity opposite to that of the boosted voltage VSH with respect to the liquid crystal center potential VMID as a center.

In the power source circuit for driving the liquid crystal of the embodiment as described above, the booster power source circuit 240 for generating the voltages VGH and VGL for the gate drivers is constructed by the charge pump and the boosting capacitor is constructed by an internal element, so that the number of external capacitive elements can be decreased. On the other hand, the booster power source circuit 230 for the source driver uses a switched capacitor booster circuit for obtaining a boosted voltage by precharging each of external booster capacitors and connecting the capacitive elements in series.

To decrease the number of external capacitive elements, it is desirable to construct the booster power source circuit 230 for the source driver by a booster circuit using a built-in capacitor. The switched capacitor booster circuit using an external capacitive element is used since the booster power source circuit for the source driver requires higher current supplying capability. The reason why the booster power source circuit for the source driver requires current supply capability higher than that of the booster power source circuit for the gate driver will now be described with reference to a liquid crystal pixel model of FIG. 6.

In the TFT liquid crystal panel, a plurality of gate lines and a plurality of source lines are disposed so as to cross each other, and pixels are provided at intersecting points of the gate and source lines. Each pixel is constructed, as shown in FIG. 6, a pixel capacitor Cpx formed between a pixel electrode and a facing electrode, a holding capacitor Cst for suppressing decrease in potential of the pixel electrode due to leak by compensating an insufficient capacitance, and a selection switch transistor Qs as a TFT having a drain terminal is connected to one of terminals of the pixel capacitor Cpx, a gate terminal connected to the gate line GL, and a source terminal connected to the source line SL. In such a pixel, a gate parasitic capacitance Cg of the TFT is connected to the gate line GL, and a PN junction capacitance Cj in the source region of the TFT is connected to the source line SL. Therefore, the gate driver has to drive not only the gate line GL but also the gate parasitic capacitance Cg of the TFT, and the source driver has to drive not only the source line SL but also a pixel capacitance Cpx, a hold capacitance Cst, and the PN junction capacitance Cj of the TFT.

As an example, the case where the size (the number of pixels in the horizontal direction × the number of pixels in the vertical direction) of the liquid crystal panel is X×Y, and the line AC frequency is fa will be considered. A frame cycle T is expressed as 1/(_(2fa)_). It is understood from the above description that the amplitude of a drive voltage applied to the gate line GL is (VGH−VGL), and that of a drive voltage applied to the source lie SL is (VSH−VSL). Therefore, an average current supply capability Ig_ave of the gate driver and an average current supply capability Is_ave of the source driver are expressed by the following equations.
Ig_ave=X·Cg·(VGH−VGL)·2fa·Y
Is_ave=X·{(Cpx+Cst)+Cj·Y}·(VSH−VSL)·2fa·Y

When it is assumed that the panel size X×Y is 720×270, the line AC frequency fa is 60 Hz, the gate parasitic capacitance Cg is 100 fF, the pixel capacitance Cpx is 250 fF, the hold capacitance Cst is 650 fF, the junction capacitance Cj is 100 fF, the amplitude (VGH−VGL) of the gate line drive voltage is 25V, and the amplitude (VSH−VSL) of the source line drive voltage is 5V, it is understood from the above equations that Ig_ave=0.068 mA, Is_ave=3.8 mA and that the current supply capability Is_ave of the source driver has to be higher than the current supply capability Ig_ave of the gate driver by more than two digits.

In other words, the current supply capability of the gate driver may be lower than that of the source driver. Although the amplitude of the gate line drive voltage is larger than that of the source line drive voltage, the load on the gate driver is only the wiring capacitance of the gate line GL and the gate capacitance of the TFT (in the case where the gate line GL is used as the gate electrode of the TFT, the wiring capacitance of the gate line GL) and one of Y gate lines is driven each time. In contact, the load on the source driver includes not only the wiring capacity of the source line SL but also the junction capacitance Cj of the TFT, the pixel capacitance Cpx, and the hold capacitance Cst and, moreover, has to drive all of X source lines simultaneously.

It is known that the output voltage Vout of the boosting circuit becomes lower than m times (where m denotes the multiplying power of boosting) of the input voltage Vcc by an internal loss, a voltage drop amount is proportional to the output current I_ave and inversely proportional to the operation frequency fb of the boosting circuit and a capacitance value Cb of the boosting capacitance used, and the output voltage Vout is expressed by the following equation.
Vout=m·Vcc−n·I_ave/fb·Cb
where n denotes a constant.

When the order of the voltage drop amount I_ave/fb·Cb as the product of the output current I_ave of the second term and the output impedance term 1/fb·Cb is estimated on assumption that the boosting circuit uses 10 MHz as the operation frequency fb and 100 pF as the capacitance value Cb, since the current supply capability Ig_ave of the gate driver is 0.068 mA and the current supply capability Is_ave of the source driver is 3.8 mA, I_ave/fb·Cb of the boosting circuit for the gate driver is 0.68 [V] and I_ave/fb·Cb of the boosting circuit for the source driver is 3.8 [V].

Therefore, under the conditions as described above, the voltage drop amount of the boosting circuit for the gate driver is 0.68 [V] and there is no problem. However, the voltage drop amount of the boosting circuit for the source driver is too large and it is unpractical. To solve the problem, it is an effective measure to increase the value Cb in the term of I_ave/fb·Cb of the voltage drop amount, that is, to use an external element of a large capacitance value as a boosting capacitance. In the invention, based on the result of examination, the boosting capacitor of the booster power source circuit for the gate driver is constructed by an on-chip element, thereby decreasing the number of external elements and the number of external terminals. On the other hand, an external element is used as the boosting capacitor of the boosting circuit for the source driver.

According to the result of examination, to decrease the number of external elements and the chip size of the control driver LSI of the TFT liquid crystal panel, it is sufficient to use an on-chip element as the boosting capacitor of the booster power source circuit 240 for the gate driver, it is not essential to construct the booster power source circuit 240 for the gate driver as in the embodiment. On the other hand, the boosting power source circuit 230 for the source driver is requested to have relatively high current supply capability and has to use an external element as a boosting capacitor. However, it is not essential to use a switched capacitor boosting circuit as in the embodiment. It is also possible construct the boosting power source circuit 230 for the source driver by a charge pump and use an external element as the boosting capacitor.

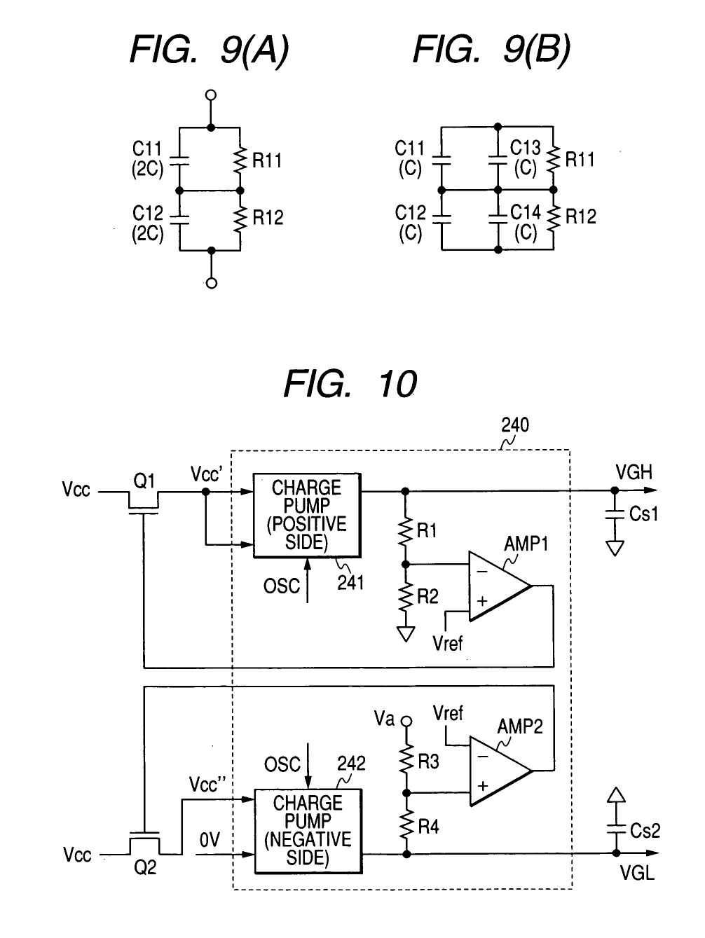

FIGS. 9A and 9B show preferred modes of the on-chip capacitive elements in the booster power source circuit 240 for the gate driver in the embodiment using on-chip elements as the boosting capacitors. As shown in FIG. 9A, capacitive elements C11 and C12 connected in series are used as on-chip capacitive elements in the booster power source circuit 240 for the gate driver, and a voltage divided by resistors R11 and R12 is applied to the connection point. With the configuration, the voltage applied to each of the boosting capacitive elements can be decreased, the withstand voltage of the capacitive elements can be decreased, and a process of reducing the withstand voltage can be employed.

In the case of using the capacitive elements C11 and C12 connected in series as shown in FIG. 9A, by setting the capacitance value of each of the elements C11 and C12 to a value 2C which is twice as large as the capacitance value C of the capacitive elements Cb1 to Cbn of the charge pump shown in FIG. 3, a combined capacitance value of the capacitive elements C11 and C12 can be set to the same as the capacitance value C of one capacitive element for boosting in FIG. 3. Consequently, when a capacitance value is determined, designing is easy. For a similar reason, as shown in FIG. 9B, the capacitive elements C11 and C12 and capacitive elements C13 and C14 connected in parallel with the capacitive elements C11 and C12 may be provided and a voltage divided by resistors R11 and R12 may be applied. In this case, by setting the capacitance value of each of the capacitive elements C11 to C14 to the same value as the capacitance value C of the capacitive element for boosting in FIG. 3, the combined capacitance value of the capacitive elements C11 to C14 can be set to the same as the capacitance value C of one capacitive element for boosting in FIG. 3.

Next, a second embodiment of the invention will be described with reference to FIG. 10. In the second embodiment, in place of the comparators 244 and 245 in the booster power source circuit 240 for the gate driver of the first embodiment of FIG. 2, error amplifiers AMP1 and AMP2 for outputting a voltage according to the potential difference of two inputs are provided, and MOS transistors Q1 and Q2 for input control are provided on the input side of the charge pumps 241 and 242, respectively, to feed back outputs of the error amplifiers AMP1 and AMP2 to the gate terminals of the MOS transistors Q1 and Q2, thereby controlling the level of an output voltage by the principle similar to that of a series regulator.

In the boosting circuit of the embodiment, by feeding back the outputs to the MOS transistors Q1 and Q2 for input control so that the voltage obtained by being divided by the resistors R1 and R2 and the resistors R3 and R4 coincides with the reference voltage Vref, the output voltage is maintained in a predetermined value. Voltages Vcc′ and Vcc″ controlled by the MOS transistors Q1 and Q2 for input control are supplied as the power source voltage of a clock driver (inverter) and an input voltage for boosting in the charge pump 241 on the positive side and as the power source voltage of a clock driver (inverter) in the charge pump 242 on the negative side, respectively.

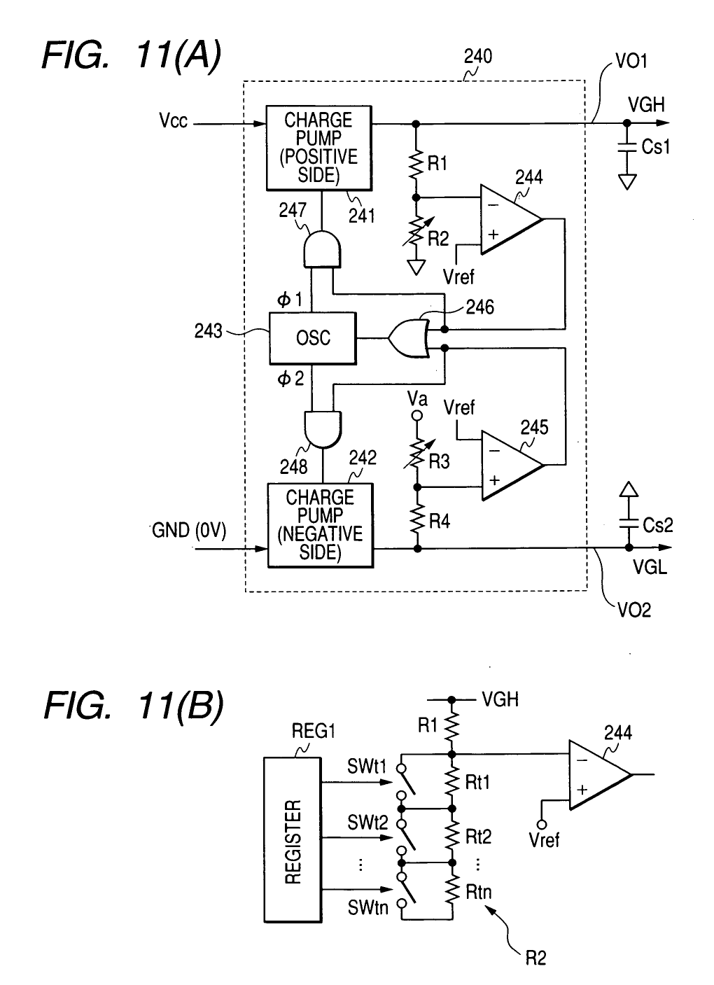

FIGS. 11A and 11B show a third embodiment of the boosting circuit according to the invention.

In the third embodiment, as shown in FIG. 11A, by using a variable resistor for one of resistors in each of the resistance dividing circuit constructed by the resistors R1 and R2 and the resistance dividing circuit constructed by the resistors R3 and R4 on the input side of the comparators 244 and 245 in the booster power source circuit 240 for the gate driver of the first embodiment shown in FIG. 2, the levels of the output boosting voltages VGH and VGL can be adjusted. By using variable resistors as the resistors R2 and R3 on the side opposite to the output node of VGH and VGL in the resistors R1 and R2 constructing the resistance dividing circuit and the resistors R3 and R4 constructing the resistance dividing circuit, low-withstand-voltage MOS transistors can be used as resistance switching elements.

Concretely, as shown in FIG. 11B, the voltage adjusting circuit is constructed by a plurality of series resistors Rt1, Rt2, . . . , and Rtn and switch elements SWt1, SWt2, . . . , and SWtn provided in parallel with the resistors, and a register REG1 for control is provided. By on/off controlling the switch elements SWt1, SWt2, . . . , and SWtn by a set value of the register REG1, the resistance value is changed, thereby adjusting the voltage applied to the comparators 244 and 245. In the embodiment, by rewriting a value to be set in the register REG1 in accordance with the specifications of a liquid crystal panel used or the display mode, the boosted voltages VGH and VGL generated ca be adjusted.

Generally, in a voltage adjusting circuit using a variable resistor and an operational amplifier, as understood from the fact that an output Vo of the operational amplifier on the charge pump 241 side is expressed as Vo=(1+R1/R2)·Vref, when the value of the resistor R1 is changed, the output can be controlled linearly so that voltage adjustment is easier. In the embodiment, however, priority is placed on decrease in the withstand voltage of the MOS transistors used as the switch elements SWt1, SWt2, . . . , and SWtn over easiness of voltage adjustment. Consequently, a low-withstand-voltage process can be used, and manufacturing cost can be reduced as compared with the case of using a high-withstand-voltage process.

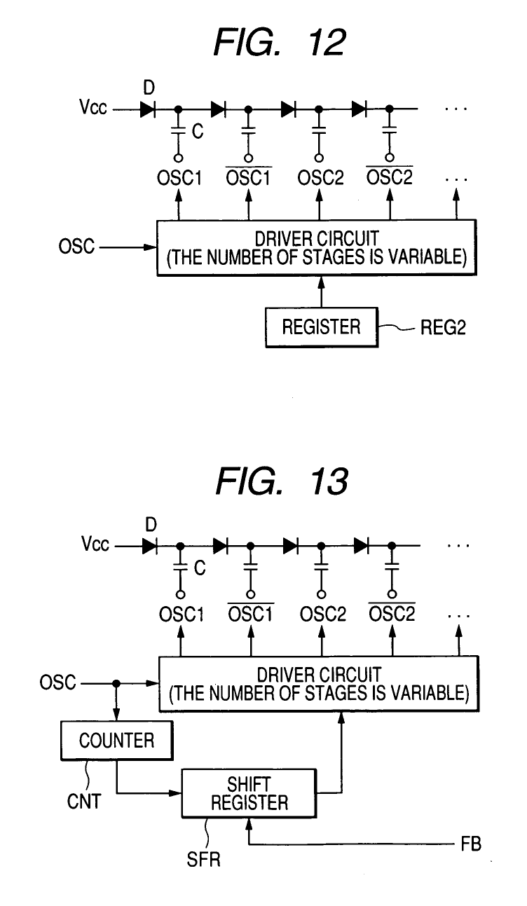

FIG. 12 shows a fourth embodiment of the boosting circuit according to the invention.

In the fourth embodiment, the number of boosting stages of the charge pumps 241 and 242 constructing the booster power source circuit 240 for the gate driver is made changeable, and is switched by a set value in a register REG2. In the fourth embodiment, for example, the set value of the register REG2 is changed in accordance with specifications of the liquid crystal panel, the display mode, or the operation mode. By switching the number of boosting stages of the charge pumps in accordance with a necessary boosting voltage value, wasted power consumption of the charge pumps can be reduced.

In the case of using a conventional charge pump in which a plurality of diode-connected MOS transistors are connected in series for switching the number of boosting stages of the charge pump, by providing a gate capable of supplying/interrupting a clock to each capacitor for boosting and controlling the number of gates which interrupt clocks, the number of stages which operate can be decreased only by an arbitrary number. The charge pumps shown in FIGS. 3A and 3B can be also constructed so that the number of stages which operate is switched to an arbitrary number by separately providing capacitors for boosting with gates capable of supplying/interrupting clocks.

FIG. 13 shows a fifth embodiment of the boosting circuit according to the invention.

In the fifth embodiment, the number of boosting stages in each of the charge pumps 241 and 242 constructing the booster power source circuit 240 for the gate driver is made switchable and is switched by a feedback signal FB from the comparator 244 (245) shown in the boosting circuit of the first embodiment of FIG. 2 or the error amplifier AMP1 (AMP2) shown in the boosting circuit of the second embodiment of FIG. 10.

More concretely, in the case where the feedback signal is sent from the comparator 244 or 245, as shown in FIG. 13, a shift register SFT and a counter CNT for counting clocks OSC or a frequency divider are provided. For example, when a boosted voltage becomes high and the feedback signal from the comparator changes to the low level, during the period of the low level, the shift register SFT is operated so as to shift in accordance with the output timing of the counter CNT to sequentially set “1” in the stages. The operation of the boosting stage corresponding to the bit “1” which is set is stopped.

On the other hand, in the case where the feedback signal is sent from the error amplifier AMP1 (AMP2), a plurality of comparators are provided for determining the level of the feedback signal. By using outputs of the plurality of comparators as signals in place of outputs of the shift registers, the number of boosting stages is switched. With such a configuration, when an output boosted voltage becomes too high, by decreasing the number of boosting stages in the charge pump, the output boosted voltage can be maintained almost constant, or wasted current consumption can be reduced.

Although the invention achieved by the inventors herein has been concretely described above on the basis of the embodiments, obviously, the invention is not limited to the foregoing embodiments but may be variously changed without departing from the gist. For example, in the embodiments, the booster power source circuit 230 for the source driver is provided with the voltage inverting circuit 232 which generates the negative voltage VSL by inverting the positive voltage VSH generated by the boosting circuit 231 around VMID as a center. Alternately, a negative voltage may be generated directly by a boosting circuit having a configuration similar to that of the boosting circuit 231.

Further, the invention can be applied to a liquid crystal control driver using the lower source line drive voltage VSL as the ground potential. The booster power source circuit 230 for the source driver may use a charge pump using an external capacitive element for boosting in place of the switched-capacitor-type boosting circuit.

The present invention achieved by the inventors herein has been described with respect to the liquid crystal control driver for driving the TFT liquid crystal panel in which a charge is injected to a pixel electrode by a thin film transistor as a three-terminal switch element in the field of use as the background of the invention. However, the invention is not limited to the liquid crystal control driver. For example, the invention can be also applied to a liquid crystal control driver for driving an MIM liquid crystal panel in which a charge is injected to a pixel electrode by a two-terminal switch element.

What is claimed is:

1. A semiconductor integrated circuit for a liquid crystal display driver for driving an active matrix liquid crystal panel and formed on a semiconductor chip, the semiconductor integrated circuit comprising:
a booster power source circuit coupled to receive an external power source voltage and for generating a voltage higher than the external power source voltage by boosting the external power source voltage, the booster power source circuit including:
a first booster power source circuit for generating a voltage to be applied to a selected scan line in the liquid crystal panel, the first booster power source circuit using built-in elements on the semiconductor chip as capacitive elements for boosting and boosting a voltage by sequentially transferring charges from a capacitive element in a first stage thereof to a capacitive element in a final stage thereof via rectifying elements or switch elements, and
a second booster power source circuit for generating a voltage to be applied to a signal line disposed in a direction intersecting the selected scan line in the liquid crystal panel, the second booster circuit boosting a voltage by using external elements as capacitive elements for boosting.

2. A semiconductor integrated circuit for a liquid crystal display driver according to claim 1,
wherein the second booster power source circuit boosts a voltage by accumulating charges in the capacitive elements for boosting which are coupled in parallel and, after that, coupling the capacitive elements for boosting in series.

3. A semiconductor integrated circuit for a liquid crystal display driver according to claim 1,
wherein the first booster power source circuit comprises:
a first boosting circuit for generating a positive boosted voltage;
a second boosting circuit for generating a negative voltage;
an oscillation circuit for generating clock signals by which the boosting circuits operate;
a first voltage detecting circuit for detecting level of the voltage generated by the first boosting circuit; and
a second voltage detecting circuit for detecting level of the voltage generated by the second boosting circuit, and
wherein when either the first or second voltage detecting circuit detects that the boosted voltage exceeds a predetermined level, operation of the corresponding one of the first and second boosting circuits is stopped.

4. A semiconductor integrated circuit for a liquid crystal display driver according to claim 3,
wherein the oscillation circuit is provided as a common circuit of the first and second boosting circuits, and
wherein when both of the first and second voltage detecting circuits detect that the boosted voltages of the first and second boosting circuits exceed the predetermined level, the operation of the oscillation circuit is stopped.

5. A semiconductor integrated circuit for a liquid crystal display driver according to claim 3,
wherein the first and second boosting circuits use a transistor as the switch element and have a boosting circuit for boosting a signal that drives a control terminal of the transistor.

6. A semiconductor integrated circuit for a liquid crystal display driver according to claim 3,
wherein each of the capacitive elements for boosting on the semiconductor chip, which is used for the first booster power source circuit is constructed by a plurality of capacitive elements coupled in series and a resistance dividing circuit for supplying a potential obtained by dividing a boosted voltage to a connection node of the capacitive elements.

7. A semiconductor integrated circuit for a liquid crystal display driver according to claim 3,
wherein each of the first and second voltage detecting circuits has:
a voltage divider for resistive-dividing boosted voltage, and
a comparator for comparing the voltage divided by the voltage divider with a predetermined reference voltage,
wherein the voltage divider includes:
a variable resistor constructed by a plurality of resistive elements coupled in series, and
switch elements provided in parallel with the resistive elements, and
wherein the variable resistor is provided on the side far from an output node in which voltage is boosted.

8. A semiconductor integrated circuit for a liquid crystal display driver according to claim 7,
wherein the switch element is constructed by a MOS transistor of a low withstand voltage.

9. A semiconductor integrated circuit for a liquid crystal display driver according to claim 3,
wherein each of the first and second boosting circuits has a drive circuit for driving a built-in element formed over a semiconductor chip as a capacitive element for boosting with an amplitude of an external power source voltage, and the drive circuit can switch the number of boosting stages of the boosting circuit.

10. A semiconductor integrated circuit for a liquid crystal display driver according to claim 9,
wherein the drive circuit can switch the number of boosting stages in accordance with a detection signal from the first or second voltage detecting circuits.

11. A semiconductor integrated circuit formed over a semiconductor chip for driving an active matrix display panel having a plurality of scan lines and a plurality of signal lines disposed in a direction intersecting the plurality of scan lines, comprising:
a first booster circuit for generating a potential to be applied to the scan lines; and
a second booster circuit for generating a potential to be applied to the signal lines,
wherein the first booster circuit uses a semiconductor element formed on the semiconductor chip as a capacitive element for boosting, and boosts a voltage by sequentially transferring a charge from a capacitive element in a first stage to a capacitive element in a final stage via a switch element, and
wherein the second booster circuit boosts a voltage by using, as a capacitive element for boosting, a plurality of capacitive elements to be externally attached to the semiconductor chip.

12. A semiconductor integrated circuit according to claim 11,
wherein the second booster circuit boosts a voltage by accumulating charges in the plurality of capacitive elements for boosting coupled in parallel and, after that, coupling the plurality of capacitive elements for boosting in series.

13. A semiconductor integrated circuit according to claim 11,
wherein the first booster circuit comprises:
a first circuit for generating a positive boosted voltage;
a second circuit for generating a negative voltage;
an oscillation circuit for generating clock signals by which the first and second circuits operate;
a first detecting circuit for detecting level of a potential generated by the first circuit; and
a second detecting circuit for detecting level of a potential generated by the second circuit, and
wherein when the first or second detecting circuit detects that the boosted voltage exceeds a predetermined level, operation of a corresponding booster power source circuits is stopped.

14. A semiconductor integrated circuit according to claim 13,
wherein the oscillation circuit is provided as a common circuit of the first and second circuits, and
wherein when both of the first and second detecting circuits detect that the boosted potential exceeds the predetermined level, the operation of the oscillation circuit is stopped.

15. A semiconductor integrated circuit according to claim 13,
wherein the switch elements of the first and second circuits are MOS transistors, and
wherein each of the first and second circuits has a boosting circuit for boosting potential of a control signal that drives a gate control terminal of the MOS transistor.

16. A display system comprising:
an active matrix liquid crystal display having a plurality of scan lines and a plurality of signal lines disposed in a direction intersecting the plurality of scan lines; and
a semiconductor integrated circuit for a liquid crystal display driver, formed over a semiconductor chip and connected to the plurality of scan lines and the plurality of signal lines of the display panel,
wherein the semiconductor integrated circuit for a liquid crystal display driver comprises:
a first booster circuit for generating a potential to be applied to the scan lines; and
a second booster circuit for generating a potential to be applied to the signal lines,
wherein the first booster circuit uses a semiconductor element formed over the semiconductor chip as a capacitive element for boosting, and boosts a voltage by sequentially transferring a charge from a capacitive element in a first stage to a capacitive element in a final stage via a switch element, and
wherein the second booster circuit boosts a voltage by using, as a capacitive element for boosting, a capacitive element to be externally attached to the semiconductor chip.
